(19) United States
(12) Patent Application Publication
(10) Pub. No.: US 2014/0091489 A1
(43) Pub. Date: Apr. 3, 2014

(54) Blowing agent introduction in polymer foam processing

(71) Applicant: TREXEL, INC., Wilmington, MA (US)

(72) Inventors: Roland Y. Kim, Andover, MA (US); Christopher J. Ball, Chelmsford, MA (US); Theodore A. Burnham, Melrose, MA (US); Levi A. Kishbaugh, Groveland, MA (US)

(73) Assignee: Trexel, Inc., Wilmington, MA (US)

(21) Appl. No.: 13/573,797

(22) Filed: Oct. 3, 2012

(51) Int. Cl. B29C 44/34

(52) U.S. Cl. CPC B29C 44/3446
USPC 264/50; 425/4 R

(57) ABSTRACT

Systems and methods of processing polymer foam materials are provided. The methods involve introducing blowing agent downstream of an extruder. For example, the blowing agent may be introduced into a static mixing device positioned between the extruder and a mold. The methods may be used in connection with injection molding systems to produce high quality injection molded polymer foam articles.

### FIELD OF INVENTION

The present invention relates generally to polymer foam processing and, more particularly, to systems and methods for introducing blowing agent into polymeric material in a polymer foam process.

### BACKGROUND

Polymer foams, including microcellular foams, may be processed by introducing blowing agent into polymeric material to form a mixture. The mixture may be further processed using a variety of techniques to form the desired article. For example, the mixture may be injected into a mold to form an injection molded polymeric foam article. In some processes, a microcellular polymeric foam article can be formed when a single-phase solution of blowing agent and polymeric material is injected into a mold such that numerous microcells are nucleated by the pressure drop in the solution during injection.

Several techniques have been used for introducing physical blowing agents into polymeric materials during processing. For example, techniques have involved pre-saturating polymer pellets with blowing agent, introducing blowing through a port in the barrel of an extruder, and introducing blowing agent through a port in the screw of an extruder. The afore-mentioned techniques result in formation of a polymer and blowing agent mixture (which may be a single-phase solution) in the extruder. To promote formation of a single-phase solution, the system may include a specially designed screw which can be expensive and add to system complexity.

During injection molding processes, the polymer and blowing agent mixture can be accumulated in the extruder downstream of the screw which creates a force on the screw in the upstream direction within the barrel. To prevent the screw from moving in the upstream direction, injection molding systems can be equipped with screw position control components which also can be expensive and add to system complexity. Otherwise, if the screw moved in the upstream direction, then pressure in the accumulated mixture would drop potentially causing undesirable nucleation and foaming within the barrel. Such foaming within the barrel can lead to formation of large cells or even voids in the resulting polymer foam article after injection. The large cells and/or voids can negatively impact foam properties (e.g., mechanical properties) and appearance.

A polymer foam processing system that did not require a specially designed screw and/or screw position control components would be desirable.

### SUMMARY

Blowing agent introduction systems, methods for introducing blowing agent, as well as related polymer processing systems and methods are described herein.

In one aspect, a polymer foam processing method is provided. The method comprises conveying polymeric material from an extruder through a valve downstream of the extruder and introducing blowing agent into the polymeric material downstream of the valve to form a mixture of polymeric material and blowing agent. The method further comprises mixing the polymeric material and blowing agent mixture in a static mixing device and introducing the polymeric material and blowing agent mixture into a mold.

In another aspect, a polymer foam processing system is provided. The system comprises an extruder designed to process polymeric material and a static mixing device positioned downstream of the extruder. The system further comprises a valve positioned between the extruder and at least a portion of the static mixing device and a blowing agent delivery system designed to introduce blowing agent into polymeric material at a location downstream of the valve. The system further comprises a mold constructed and arranged downstream of the location of blowing agent introduction.

Other aspects and features of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every FIGURE, nor is every component of each embodiment of the invention shown where illustration is not necessary to allow those of ordinary skill in the art to understand the invention. In cases where the present specification and a document incorporated by reference include conflicting disclosure, the present specification shall control.

### BRIEF DESCRIPTION OF DRAWINGS

FIG. 1 shows a foam polymer processing system according to an embodiment.

### DETAILED DESCRIPTION

Systems and methods of processing polymer foam materials are provided. The methods involve introducing blowing agent into polymeric material at a location downstream of the extruder. For example, the blowing agent may be introduced into polymeric material within a static mixing device positioned between the extruder and a mold. In such embodiments, the static mixing device can thoroughly mix the blowing agent and polymeric material to form a mixture (e.g., a single-phase solution) which is subsequently injected into the mold to form the desired polymeric foam article (e.g., a microcellular foam article). As described further below, in some embodiments, a valve is provided between the extruder and at least a portion of (or the entire) the static mixing device which limits the upstream flow of the polymeric material and blowing mixture to the extruder. The foam processing system advantageously does not require a specially designed screw that promotes blowing agent mixing and/or screw position control components which maintain screw position, amongst other advantages. Consequently, the system design can be simplified as compared to certain foam processing systems and costs can be saved.

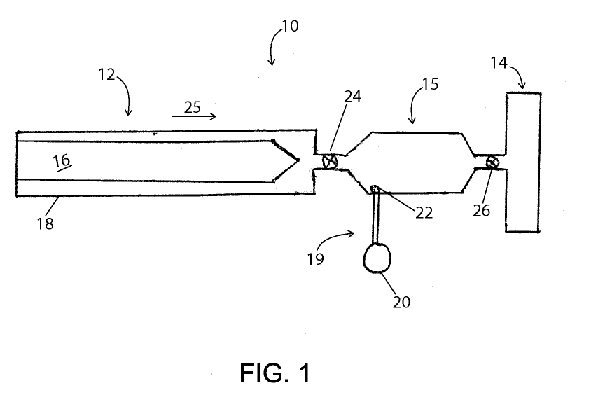

FIG. 1 illustrates a polymer foam processing system 10 according to an embodiment. In this embodiment, the system is an injection molding system with an extruder 12 and a mold 14. The extruder includes a screw 16 designed to rotate within a barrel 18 to process polymeric material. As described further below, the system includes a static mixing device 16 between the extruder and the mold. In the illustrated embodiment, a blowing agent introduction system 18 includes a source 20 of blowing agent that is connected to one or more port(s) 22 in the static mixing device. A valve 24 is positioned upstream of the port and between an outlet of the extruder and at least a portion of the (or the entire) static mixing device. In this embodiment, an optional shut-off nozzle 26 is positioned between an outlet of the static mixing device and an inlet of the mold.

During processing, the screw rotates to convey polymeric material in a downstream direction within the extruder. The polymeric material may then be conveyed through an outlet of the extruder and then through valve 24. In some embodiments, the polymeric material may be conveyed through the valve as a result of the downstream motion of the screw within the barrel, and in some cases the polymeric material may be conveyed through the valve as a result of screw rotation. Polymeric material may be accumulated downstream of the screw within the extruder causing the screw to retract in an upstream direction within the barrel. At a suitable time, the screw stops retracting and rotating, and may be forced in a downstream direction 25 to convey polymeric material through an outlet of the extruder, through valve 24 and through the static mixing device.

Blowing agent is introduced into the polymeric material as it flows past the port(s) to form a mixture of polymeric material and blowing agent. The mixture is mixed within the static mixing device and, in some embodiments, a single-phase solution is formed. The shut-off nozzle, when closed, prevents flow into the mold so that the mixture accumulates within the static mixing device. The valve limits (e.g., substantially prevents) the accumulating and expanding mixture from flowing upstream from the static mixing device back into the extruder. Polymeric material, without blowing agent, also accumulates downstream of the rotating screw which also retracts in an upstream direction within the barrel. At a suitable time, the screw stops retracting and rotating, and is forced in a downstream direction 25 within the barrel. In some embodiments, it is advantageous to discontinue blowing agent introduction for at least a portion of the time that the screw moves in the downstream direction, as described further below. The downstream motion of the screw causes a portion of the polymeric material and blowing agent mixture to be injected from the static mixing device into the mold when the shut-off nozzle opens. The mixture is subjected to a pressure drop during injection which nucleates a large number of cells and a polymer foam article is formed in the mold. The screw begins to rotate once again and the process is typically repeated to produce additional foam articles.

It should be understood that polymer foam processing system may include a number of conventional components not illustrated in the FIGURE. For example, the system may include a control system which contributes to controlling the operation of different components such as the opening and closing of valves and shut-off nozzles, rotation and movement of the screw, amongst other operations.

Any of a wide variety of physical blowing agents known to those of ordinary skill in the art such as nitrogen, carbon dioxide, hydrocarbons, chlorofluorocarbons, and the like, and mixtures, can be used. In some preferred embodiments, the source provides carbon dioxide, or nitrogen, or a mixture thereof as a blowing agent. Blowing agents that are in the supercritical state in the extruder may be preferred in some embodiments, particularly supercritical carbon dioxide and/or nitrogen.

In some embodiments nitrogen is used in combination with other blowing agents such as carbon dioxide, and in other embodiments nitrogen is used alone with no other blowing agents present. In other embodiments nitrogen can be used with other blowing agents so long as the other blowing agents do not materially alter the blowing process. When carbon dioxide is used, similarly it can be used alone, in combination with another blowing agent (e.g. nitrogen) that adds to or changes the blowing agent properties, or in combination with another agent that does not materially change the blowing process

In some embodiments, the blowing agent introduction system may include a metering device (or system) 28 between the blowing agent source and the port(s). The metering device can be used to meter the blowing agent so as to control the amount of the blowing agent in the polymeric stream within the extruder to maintain a level of blowing agent at a particular level. In some preferred embodiments, the device meters the mass flow rate of the blowing agent. The blowing agent is generally less than about 10% by weight of polymeric stream and blowing agent; in some embodiments, the blowing agent may be less than about 5% by weight of polymeric stream and blowing agent; in some embodiments, the blowing agent may be less than about 2.5% by weight of polymeric stream and blowing agent; and, in some embodiments, the blowing agent may be less than about 1% by weight of polymeric stream and blowing agent.

When carbon dioxide is used as a blowing agent, it may be possible in some embodiments to use relatively low amounts of blowing agent such as less than about 2.5%, or less than about 1%, by weight of polymeric stream and blowing agent.

When nitrogen is used as a blowing agent, it may be possible in some embodiments to use very low amounts of blowing agent such as less than about 1.0%, less than about 0.5%, or less than about 0.1%, by weight of polymeric stream and blowing agent.

In some embodiments, blowing agent is introduced discontinuously into the polymeric material. That is, blowing agent introduction may be stopped during a portion of the process. For example, it may be advantageous for the blowing agent flow to be stopped during at least a portion of the time when the polymeric material and blowing agent mixture is being injected into the mold. In some embodiments, is may be preferable for blowing agent flow to be stopped for substantially all of the time when the polymeric material and blowing agent mixture is being injected into the mold. During injection, the polymeric material and blowing agent are subjected to high pressures which would need to be exceeded by the blowing agent pressure if the blowing agent is to be introduced into the polymeric material. Thus, by avoiding the introduction of blowing agent during injection, the blowing agent introduction system may not be required to introduce blowing agent at high pressures. Alleviating this requirement can simplify the design of the blowing agent introduction system (e.g., a high pressure pump may not be required) which can result in cost savings. Thus, some embodiments feature blowing agent introduction into polymeric material at low pressures (e.g., less than 2500 psi, less than 2000 psi, less than 1500 psi, and the like).

As noted above, blowing agent may be introduced through one or more ports. In the illustrated embodiment, the port(s) are formed at an upstream end of the static mixing device. In other embodiments, the port(s) may be positioned upstream of the static mixing device (e.g., in a separate component between the static mixing device and the extruder), while still being downstream of the extruder outlet and valve 24.

In some embodiments, a single port is provided. In other embodiments, multiple ports may be provided. When multiple ports are present, the ports may be arranged at substantially the same axial position in the system but at different radial positions; or, the ports may be arranged at different axial positions (e.g., one port is downstream the other port).

In some embodiments, a blowing agent injector assembly may be positioned within the port(s). The injector assembly may include a plurality of small orifices through which blowing agent flows on its pathway into the polymeric material.

Valve 24 may have any suitable construction. For example, the valve may be a ball check valve, a ring check valve, a needle valve or a rotary valve.

The valve is positioned upstream of the location of blowing agent introduction. In general, the valve is positioned downstream of the extruder outlet. In some embodiments and as shown, the valve may be associated with the inlet of the static mixing device. That is, in these embodiments, the valve is positioned at, or proximate, the inlet of the static mixing device. Also, in these embodiments, the valve can be positioned between the extruder outlet and the entire static mixing device. In other embodiments, the valve may be further downstream so that a portion of the static mixing device may be upstream of the valve and a portion of the static mixing device may be downstream of the valve. It should also be understood that the valve may be positioned in a separate component between the extruder and the static mixing device.

The valve is designed to limit the upstream flow of the mixture of polymeric material and blowing agent. In typical embodiments, the valve substantially prevents the upstream flow of the mixture, though, in some cases, a small amount of upstream flow past the valve may be acceptable. The upstream flow of the mixture from the static mixing device to the extruder may be substantially prevented in some embodiments. This eliminates a pressure drop that might otherwise occur in the mixture if it flowed from the static mixing device to the extruder. Such pressure drops can be detrimental to the process because they can lead to premature cell nucleation in the barrel or static mixing device which can result in larger cells and/or voids being formed in the injection molded foam article.

The static mixing device may have any suitable construction. In general, the static mixing device includes mixing elements which are used to mix the polymer and blowing agent, as the polymer and blowing agent move through the flow path within the static mixing device. A series of the mixing elements may be arranged within a housing between an inlet of the mixer and an outlet. For example, the different mixing elements may be arranged in an axial direction. The static mixing device may have a length to diameter ratio of less than or equal to 10:1; in some cases, less than or equal to 6:1; and, in some cases, less than or equal to 4:1. It should be understood that the system may include more than one static mixing device in a combined configuration (e.g. configured in series). In such embodiments, the combined configuration of static mixing devices may have a length to diameter ratio of less than or equal to 10:1; in some cases, less than or equal to 6:1; and, in some cases, less than or equal to 4:1

In general, the static mixing device includes mixing elements that are entirely or primarily static. Entirely or primarily static mixing elements are not driven to turn by a motor. Entirely static mixing elements are fixed, while primarily static mixing elements may be able to turn and/or are driven to turn by a small degree through the flow of polymer through the mixing device.

In some embodiments, the system may include a mixing device that does not significantly convey polymeric material in a downstream direction. For example, in some embodiments, the mixing device conveys polymeric material from its inlet to its outlet at a rate less than 25% the rate of delivery of the polymeric material from the extruder. In some embodiments, the mixing device conveys polymeric material from its inlet to its outlet at a rate less than 10% the rate of delivery of the polymeric material from the extruder. In some embodiments, the mixing device essentially does not convey polymeric material at all. In the static mixing device, polymer flows through the device primarily (or entirely) as a result of a force pushing the polymeric material in a downstream direction. Such forces can arise from polymeric material being injected from the extruder into the mixing device, for example, due to screw rotation and/or the downstream motion of the screw during injection.

In some embodiments, a single-phase solution of blowing agent and polymer may be formed in the static mixing device. Formation of a single-phase solution may be particularly conducive to forming a foam structure having small cell sizes. However, it should be understood that, in some embodiments, a single-phase solution may not be formed.

In some processes (e.g., processes in which a single-phase solution is formed), microcellular foam articles may be produced. The microcellular foam articles may have an average cell size of less than 100 microns. Suitable microcellular foam articles have been described in commonly-owned U.S. Pat. No. 6,884,823 which is incorporated herein by reference above in its entirety. However, it should be understood that non-microcellular foam articles may also be produced using the systems and methods described herein in some embodiments.

The polymeric foams produced may have a wide range of void fractions. The particular void fraction will depend upon the application. In some embodiments, the void fraction is less than 50%; in other embodiments, the void fraction is less than 25%; and, in some embodiments, the void fraction is less than 20%. Any polymeric material suitable for forming polymeric foams may be used with the systems and methods of the invention. Such polymeric materials, in some cases, are thermoplastics which may be amorphous, semicrystalline, or crystalline materials. Typical examples of polymeric materials used include styrenic polymers (e.g., polystyrene, ABS), polyolefins (e.g., polyethylene and polypropylene), fluoropolymers, polyamides, polyimides, polyesters, and the like. The polymeric material used depends upon the application.

The present system and methods process polymeric foams, as described above, using a physical blowing agent and, thus, is generally free of residual chemical blowing agents or reaction byproducts of chemical blowing agents. Optionally, the polymeric material may include a nucleating agent, such as talc or calcium carbonate. In other embodiments, the polymeric foams may be free of a nucleating agent. The polymeric foams may also include any number of other additives known in the art such as lubricants, plasticizers, colorants, fillers and the like.

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, or method described herein. In addition, any combination of two or more such features, systems or methods, if such features, systems or methods are not mutually inconsistent, is included within the scope of the present invention.

What is claimed is:

1. A polymer foam processing method comprising:
conveying polymeric material from an extruder through a valve downstream of the extruder;
introducing blowing agent into the polymeric material downstream of the valve to form a mixture of polymeric material and blowing agent;
mixing the polymeric material and blowing agent mixture in a static mixing device; and
introducing the polymeric material and blowing agent mixture into a mold.

2. The method of claim 1, wherein the extruder includes a reciprocating screw.

3. The method of claim 1, wherein the valve is constructed and arranged to limit upstream flow of the polymeric material and blowing agent mixture into the extruder.

4. The method of claim 1, wherein the valve is constructed and arranged to substantially prevent upstream flow of the polymeric material and blowing agent mixture into the extruder.

5. The method of claim 1, further comprising forming a polymeric material and blowing agent single-phase solution in the static mixing device.

6. The method of claim 1, further comprising moving the screw in a downstream direction to introduce the polymeric material and blowing agent mixture into the mold.

7. The method of claim 1, further comprising moving the screw in a downstream direction to convey the polymeric material and blowing agent mixture through the static mixing device.

8. The method of claim 1, further comprising moving the screw in a downstream direction to convey the polymeric material and blowing agent mixture through the static mixing device and to introduce the mixture into the mold.

9. The method of claim 1, wherein the blowing agent is introduced into the polymeric material through one or more ports in the static mixing device.

10. The method of claim 1, wherein the blowing agent is introduced discontinuously into the polymeric material.

11. The method of claim 10, wherein blowing agent is not introduced during at least a portion of the step of introducing the polymeric material and blowing agent mixture into the mold.

12. The method of claim 10, wherein blowing agent is not introduced during substantially all of the step of introducing the polymeric material and blowing agent mixture into the mold.

13. The method of claim 10, wherein blowing agent is introduced during the step of extruding polymeric material from the extruder through the valve.

14. The method of claim 1, wherein blowing agent is introduced into the polymeric material at a pressure of less than 2500 psi.

15. The method of claim 1, wherein the blowing agent comprises nitrogen.

16. The method of claim 1, comprising injecting the polymeric material and blowing agent mixture into a mold to form a microcellular polymeric foam having an average cell size of less than 100 microns.

17. A polymer foam processing system comprising:
an extruder designed to process polymeric material;
a static mixing device positioned downstream of the extruder;
a valve positioned between the extruder and at least a portion of the static mixing device;
a blowing agent delivery system designed to introduce blowing agent into polymeric material at a location downstream of the valve; and
a mold constructed and arranged downstream of the location of blowing agent introduction.

18. The system of claim 17, wherein the static mixing device includes at least one port and the blowing agent delivery system is designed to introduce blowing agent through the port into polymeric material within the static mixing device.

19. The system of claim 18, wherein the static mixing device includes multiple ports and the blowing agent delivery system is designed to introduce blowing agent through the port into polymeric material within the static mixing device.

20. The system of claim 17, wherein the valve is constructed and arranged to limit upstream flow of the polymeric material and blowing agent mixture into the extruder.

21. The system of claim 17, wherein the valve is constructed and arranged to substantially prevent upstream flow of the polymeric material and blowing agent mixture into the extruder.

22. The system of claim 17, further comprising a shut-off nozzle positioned between an outlet of the static mixing device and an inlet of the mold.

23. The system of claim 17, wherein the blowing agent delivery system comprises a nitrogen source.
